(19) United States
(12) Patent Application Publication
(10) Pub. No.: US 2025/0286598 A1
(43) Pub. Date: Sep. 11, 2025

(54) CHANNEL STATE INFORMATION REPORTING

(71) Applicant: Intel Corporation, Santa Clara, CA (US)

(72) Inventors: Alexei Davydov, Nizhny Novgorod (RU); Dmitry Dikarev, Nizhny Novgorod (RU); Dae Won Lee, Portland, OR (US); Yingyang Li, Beijing (CN); Gang Xiong, Beaverton, OR (US)

(21) Appl. No.: 18/279,185

(22) PCT Filed: Mar. 1, 2022
(86) PCT No.: PCT/US2022/018367

§ 371 Date: Aug. 28, 2023

Related U.S. Application Data
(60) Provisional application No. 63/159,916, filed on Mar. 11, 2021.
(60) Provisional application No. 63/176,084, filed on Apr. 16, 2021.

(51) Int. Cl. H04B 7/06; H04L 5/00; H04L 27/26

(52) U.S. Cl. CPC H04B 7/0632; H04B 7/0626; H04L 5/0044; H04L 27/2636

(57) ABSTRACT

An apparatus and system for channel quality indication (CQI) and aperiodic reporting are described. The UE is configured to use demodulation reference signals (DM-RS) of a physical downlink control channel (PDCCH) or channel state information (CSI) reference signals (CSI-RS) for beam management for CSI reporting. The UE calculates the CQI from the DM-RSI or CSI-RS and sends the CQI to the gNB. The CQI configuration includes power offsets to be applied to the channel measurements for evaluation of the block error rate (BLER) depending on the CQI. Different power offsets are applied for different CQI groups that are determined by the modulation order associated with the calculated CQI.

### PRIORITY CLAIM

This application claims the benefit of priority to U.S. Provisional Patent Application Ser. No. 63/159,916, filed Mar. 11, 2021, and U.S. Provisional Patent Application Ser. No. 63/176,084, filed Apr. 16, 2021, each which is incorporated herein by reference in its entirety.

### TECHNICAL FIELD

Embodiments pertain to next generation (NG) wireless communications. In particular, some embodiments relate to aperiodic reporting of channel state information, including a channel quality indication.

### BACKGROUND

The use and complexity of new radio (NR) wireless systems, which include 5^{th} generation (5G) networks and are starting to include sixth generation (6G) networks among others, has increased due to both an increase in the types of devices UEs using network resources as well as the amount of data and bandwidth being used by various applications, such as video streaming, operating on these UEs. With the vast increase in number and diversity of communication devices, the corresponding network environment, including routers, switches, bridges, gateways, firewalls, and load balancers, has become increasingly complicated. As expected, a number of issues abound with the advent of any new technology.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates aperiodic channel state information (CSI) and channel state information reference signal (CSI-RS) triggering in accordance with some aspects.

FIG. 4 illustrates aperiodic CSI and CSI-RS triggering in accordance with some aspects.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

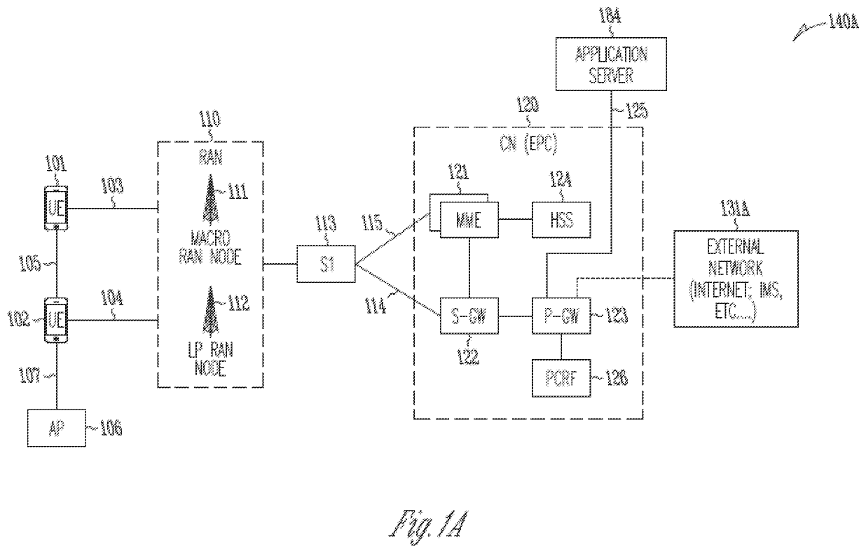

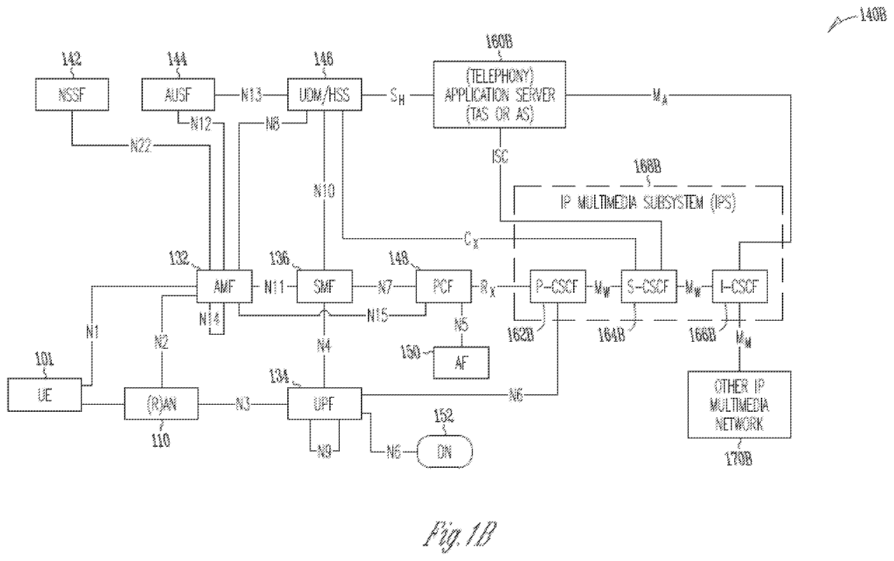

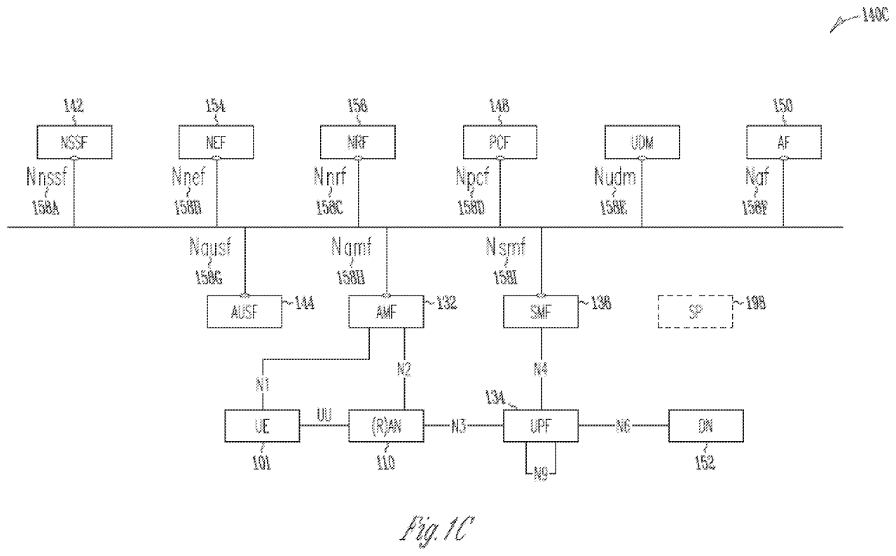

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs). NodeBs, evolved NodeBs (eNBs), Next Generation (5^{th} or 6^{th} generation) NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 11l and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NO system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown). N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156). Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

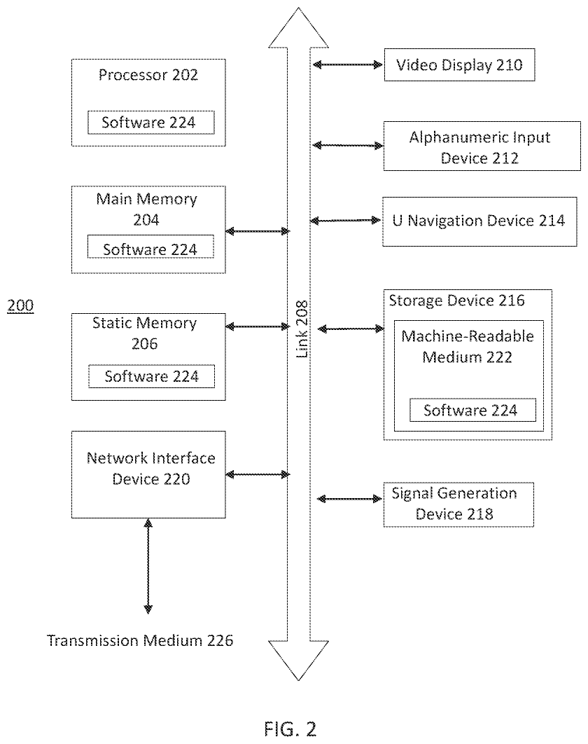

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11 ad, IEEE 802.11 ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5.905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

Some of the features are defined for the network side, such as APs, eNBs, NR or gNBs—note that this term is typically used in the context of 3GPP 5G and 6G communication systems, etc. Still, a UE may take this role as well and act as an AP, eNB, or gNB; that is some or all features defined for network equipment may be implemented by a UE.

5G NR supports dynamic adaptation of the transmission parameters to the actual link conditions. More specifically, depending on the CSI, the gNB may indicate the optimal number of multiple input multiple output (MIMO) layers and the modulation and coding scheme (MCS) to the UE and assign preferred precoding for the physical downlink shared channel (PDSCH) transmission. The preferred number of MIMO layers and precoder for DL transmission are provided by the UE using rank indicator (RI) and precoding matrix indicator (PMI) reports. The preferred modulation order and the target coding rate is provided by the UE using a channel quality indicator (CQI). The RI, PMI and CQI are reported by the UE using uplink control information (UCI) that is transmitted by the UE on the physical uplink control channel (PUCCH) or physical uplink shared channel (PUSCH) channels.

The UE derives the CQI value and reports the CQI value as a CQI index by choosing a PDSCH transport block corresponding to the CSI reference resource with a modulation, code rate and transport block size corresponding to a CQI index that could be received with block error rate (BLER) not exceeding a predetermined BLER threshold, e.g., 0.1. An example CQI table supported in 5G NR is provided in Table 5.2.2.1-2 of TS 38.214 v16.4.0, reproduced below for convenience:

TABLE 5.2.2.1-2
4-bit CQI Table

| CQI index | modulation | code rate × 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

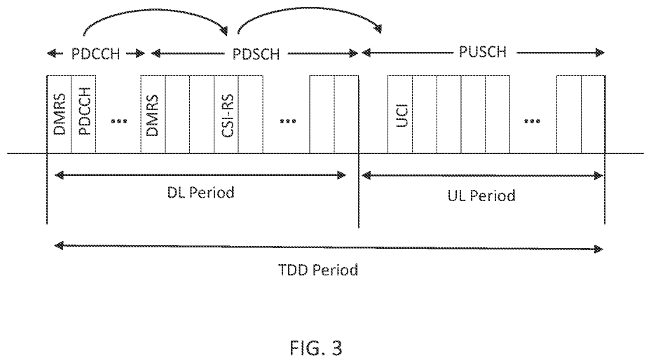

The CQI value is typically derived by the UE using channel measurements on the CSI-RS. The CSI-RS can be periodic, semi-persistent, or aperiodic. An aperiodic CSI-RS is triggered together with a CSI report by an indication in the downlink control information (DCI) of a physical downlink control channel (PDCCH). FIG. 3 illustrates aperiodic CSI and CSI-RS triggering in accordance with some aspects. For 6G systems operating in sub-THz or THz bands, the most common propagation condition between the transmitter and receiver is line of sight (LOS) (or LOS-like). In such channels, mutual interference between two polarizations is insignificant, making multiple MIMO layer transmission more efficient than single MIMO layer transmission in most cases. In addition, due to larger subcarrier spacing (SCS), support of more efficient and low latency mechanisms of CQI reporting becomes more important considering the short duration of discrete Fourier transform spread orthogonal frequency division multiplexing (DFT-s-OFDM symbols).

Thus, it is desirable to reduce the amount of time between detection of the PDCCH triggering aperiodic reference signal measurement and transmission of the UCI containing the measurement information. To this end, in some embodiments, CQI can be derived by the UE based on channel and interference measurements on demodulation reference signals (DM-RS) of the PDCCH (which have already been decoded). More specifically, after detection of a DCI triggering aperiodic CSI transmission with CQI, the UE derives the CQI using channel/interference estimated by the UE for demodulation of the PDCCH that was used for transmission of the corresponding DCI (i.e., the DM-RS is used to calculate the CQI, rather than the CSI-RS). Since the channel measurements (and post-processing signal-to-interference and noise ratio (SINR)) for some receiver structures are already available for demodulation of the PDCCH, the CQI calculation and reporting latency can be significantly reduced comparing to the current system relying on CSI-RS transmission and measurement for CSI reports. In this case, use (and transmission of) the CSI-RS can be avoided. In another embodiment, the PDCCH used for CQI calculation can also transmit a downlink (DL) DCI, uplink (UL) DCI or a joint DL+UL DCI.

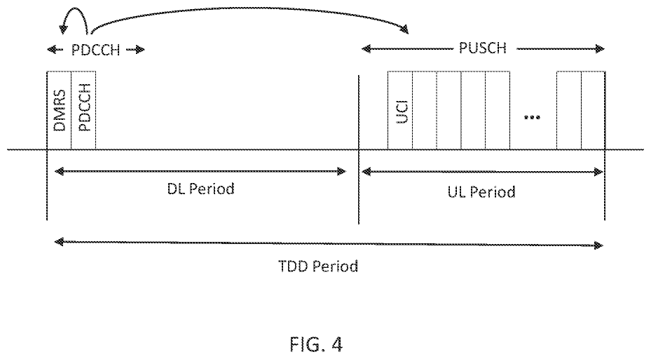

Accordingly, FIG. 4 illustrates aperiodic CSI and CSI-RS triggering in accordance with some aspects. As shown in FIG. 4, the CSI reference resource corresponds to a DFT-s-OFDM symbol with a DM-RS of the PDCCH that was used for DCI transmission within a DL period of a TDD period. Further, the offset and periodicity of the DM-RS associated with the PDCCH can be configured by higher layers via radio resource control (RRC) signaling. Note that the offset and periodicity may be configured on a per symbol basis or on a per symbol group basis. The reference time can be based on the frame boundary. In other embodiments, the CSI reference resource may further include (or may be) the PDCCH that was used for the DCI transmission. That is, both the DM-RS and the PDCCH itself may be used to determine the CQI (the PDCCH being used to further refine the CQI after an initial CQI calculation using the DM-RS).

In other embodiments, the UE is configured with a power offset parameter that is able to be used by the UE for the CQI calculation. More specifically, the power offset indicates the power ratio between the DM-RS and PDSCH for which the CQI is calculated. The power offset can be explicitly provided by the DCI or implicitly derived from the DCI. For example, the power offset may depend on the aggregation level (AL) of the PDCCH (i.e., the number of CCEs allocated for the PDCCH). In other embodiment, the power offset can be provided by RRC signaling. The power offset can be common, modulation, or MCS dependent.

In some embodiments, UCI transmission on the PUSCH may be performed in the first (i.e., soonest after the PDCCH) DFT-s-OFDM symbol that satisfies the UE capability for Z. Z is the minimum time between the last symbol of the PDCCH and the first symbol of the UCI. In this embodiment, the gNB provides a UE time offset between the last symbol of the PDCCH and the first symbol of the UCI in which the time offset is greater than or equal to the value Z. For example, the time offset of UCI reporting can be configured for each CSI request codepoint, triggering aperiodic CSI-RS transmission and CSI reporting. The corresponding embodiment is illustrated in FIG. 4, in which the UCI is transmitted in the UL period of the TDD period in which the PDCCH and DM-RS were transmitted Error! Reference source not found. Z may be indicated in UE Capability information transmitted from the UE to the gNB.

Although the UCI shown in FIG. 4 is in the first portion (symbol) of the PUSCH transmission, in other embodiments the UCI may be located in other parts of the PUSCH transmission—e.g., in the middle of or in the last part of PUSCH transmission.

The time offset may be configured by higher layers via RRC signaling or indicated in the DCI or a combination thereof. Thus, although the UCI shown in FIG. 4 is in the UL transmission (PUCCH or PUSCH) immediately after the PDCCH requesting aperiodic UCI reporting (i.e., the UL period of the TDD period), the gNB controls the timing of the UCI containing the UCI report (with the CQI). The gNB may thus indicate a time offset of UCI reporting that in which the CQI is indicated to the UE to be sent not in the next scheduled UL transmission but in an UL transmission after the next UL transmission (e.g., the 2^{nd} or 3^{rd} UL transmission after the PDCCH—i.e., of a TDD period different from the TDD period containing the PDCCH and DM-RS).

In another embodiment, the CQI value is derived based on an MCS table and the CQI index may correspond to the index of the MCS from MCS table. For example, the CQI can be derived from the MCS table illustrated in Table 1 using 6 bits CQI field.

TABLE 1
MCS table for MCS indication and CQI reporting

| | | R × | Per layer |
|---|---|---|---|
| I_{MCS} | Qₘ | 1024 | SE |
| 0 | 1 | 132 | 0.1289 |
| 1 | 1 | 152 | 0.1484 |
| 2 | 1 | 178 | 0.1738 |
| 3 | 1 | 206 | 0.2012 |
| 4 | 1 | 238 | 0.2324 |
| 5 | 1 | 276 | 0.2695 |
| 6 | 1 | 320 | 0.3125 |
| 7 | 1 | 368 | 0.3594 |
| 8 | 2 | 119 | 0.2324 |
| 9 | 2 | 138 | 0.2695 |
| 10 | 2 | 160 | 0.3125 |
| 11 | 2 | 184 | 0.3594 |
| 12 | 2 | 210 | 0.4102 |
| 13 | 2 | 237 | 0.4629 |
| 14 | 2 | 255 | 0.498 |
| 15 | 2 | 294 | 0.5742 |
| 16 | 2 | 342 | 0.668 |
| 17 | 2 | 382 | 0.7461 |
| 18 | 2 | 424 | 0.8281 |
| 19 | 2 | 467 | 0.9121 |
| 20 | 2 | 516 | 1.0078 |
| 21 | 2 | 561 | 1.0957 |
| 22 | 2 | 602 | 1.1758 |
| 23 | 2 | 651 | 1.2715 |
| 24 | 2 | 700 | 1.3672 |
| 25 | 2 | 750 | 1.4648 |
| 26 | 2 | 799 | 1.5605 |
| 27 | 4 | 404 | 1.5781 |
| 28 | 4 | 440 | 1.7188 |
| 29 | 4 | 477 | 1.8633 |
| 30 | 4 | 517 | 2.0195 |
| 31 | 4 | 560 | 2.1875 |
| 32 | 4 | 594 | 2.3203 |
| 33 | 4 | 637 | 2.4883 |
| 34 | 4 | 680 | 2.6563 |
| 35 | 4 | 720 | 2.8125 |
| 36 | 4 | 759 | 2.9648 |
| 37 | 4 | 800 | 3.125 |
| 38 | 4 | 837 | 3.2695 |
| 39 | 4 | 867 | 3.3867 |
| 40 | 6 | 580 | 3.3984 |
| 41 | 6 | 614 | 3.5977 |
| 42 | 6 | 648 | 3.7969 |
| 43 | 6 | 683 | 4.002 |
| 44 | 6 | 715 | 4.1895 |
| 45 | 6 | 747 | 4.377 |
| 46 | 6 | 775 | 4.541 |
| 47 | 6 | 807 | 4.7285 |
| 48 | 6 | 837 | 4.9043 |
| 49 | 6 | 866 | 5.0742 |
| 50 | 6 | 892 | 5.2266 |
| 51 | 8 | 665 | 5.1953 |
| 52 | 8 | 694 | 5.4219 |
| 53 | 8 | 718 | 5.6094 |
| 54 | 8 | 745 | 5.8203 |
| 55 | 8 | 772 | 6.0313 |
| 56 | 8 | 799 | 6.2422 |
| 57 | 8 | 824 | 6.4375 |
| 58 | 8 | 847 | 6.6172 |
| 59 | 8 | 870 | 6.7969 |
| 60 | 8 | 893 | 6.9766 |
| 61 | 8 | 913 | 7.1328 |
| 62 | 8 | 932 | 7.2813 |
| 63 | 8 | 950 | 7.4219 |

In another embodiment, the CQI value is derived by the UE based on a measurement on a CSI-RS configured for a beam management P2 (gNB scanning over different beams, UE uses single beam), P3 (UE scanning over different beams, gNB uses single beam) and P2+P3 procedure. The CQI report can be provided together with the CSI-RS resource index (CRI) report indicating preferred beamforming for DL/UL transmissions.

In another embodiment, a different power backoff at the transmitter can be used to satisfy error vector magnitude (EVM) and power spectrum mask requirements. For example, higher order modulations, which are more sensitive to EVM, can be transmitted with a larger power backoff to reduce the impact of RF impairments such as power amplifier non-linearities. At the same time, low order modulations, especially low peak-to-average power ratio (PAPR) modulation such as pi/2 binary phase-shift keying (BPSK) can be transmitted with lower power backoff to increase the coverage of the transmission. To support such transmission, the reported CQI should take into account the possible reduction on the transmission power. In one embodiment, the UE can be provided with the set of the power offsets that the UE is to apply to the DM-RS channel measurements for evaluation of the BLER for the set of the CQI. The set of the CQI can be determined by the modulation order corresponding to the CQI. The power offset can be pre-determined or configured to the UE as part of the CQI configuration. Upon configuration, the UE scales the channel measurements depending on the CQI evaluated for the BLER.

In another embodiment, the DM-RS of the PDSCH can be also used for CQI selection. In this case the same approach can be used to scale the channels with the difference that the scaling takes into account the MCS (or the modulation order) of the scheduled PDSCH.

In another embodiment, the use of the DM-RS of the PDCCH or the PDSCH for BLER evaluation may also depend on the CQI. For example, for a CQI with pi/2 BPSK modulations, the channel measurements obtained from the DM-RS of PDCCH can be used, while for all other CQI, the channel measurements obtained from the DM-RS of the PDSCH can be used.

Accordingly, in some embodiments a system and method of channel quality calculation and reporting from the UE to the gNB each include configuring the UE with CSI reporting using DM-RS of a PDCCH, requesting CSI reporting using a DCI transmitted in a PDCCH, calculating of CSI reporting based on measurements of the DM-RS of the PDCCH, and reporting the calculated CSI from the UE to the gNB based on the CSI reporting configuration. Thus, the DM-RS used for the CSI calculation and the DM-RS of PDCCH with DCI containing CSI request are the same.

In some embodiments, the CSI is channel quality information (CQI). In this case, the CQI may correspond to a 2 MIMO layer transmission and the DM-RS of PDCCH has 2 antenna ports.

In some embodiments, a power offset is applied by the UE to the DM-RS measurements before the CQI calculation.

In some embodiments, a power offset is configured by RRC signaling and depends on the modulation order or CQI index.

In some embodiments, the CQI value is selected based on a MCS table and reported using an MCS index of the MCS table.

In some embodiments, a system and method of channel quality calculation and reporting from the UE to the gNB each include configuring the UE with CSI reporting using a CSI-RS for beam management, requesting CSI reporting using a DCI transmitted in a PDCCH, calculating of CSI reporting based on measurements of the CSI-RS, and reporting the calculated CSI from the UE to the gNB based on the CSI reporting configuration.

In some embodiments, the CQI configuration may include signaling or an indication of two or more power offsets to be applied to the channel measurements for evaluation of the BLER depending on the CQI.

In some embodiments, the different power offsets are applied for different CQI groups that are determined by the modulation order associated with the calculated CQI.

In some embodiments, the channel measurements obtained from the DM-RS of the PDCCH and channel measurement PDSCH can be applied to evaluation of different sets of CQIs.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An apparatus for a 5^{th} generation NodeB (gNB), the apparatus comprising:
processing circuitry to configure the gNB to:
transmit, to a user equipment (UE), demodulation reference signals (DM-RS) and downlink control information (DCI) of a physical downlink control channel (PDCCH) during a downlink (DL) period of a time domain duplexing (TDD) period, the DCI requesting channel state information (CSI) reporting; and
in response to transmission of the DM-RS and DCI, receive, from the UE, uplink control information (UCI) of a physical uplink control channel (PUCCH) or physical uplink shared channel (PUSCH), the UCI containing a channel quality indicator (CQI) calculated using the DM-RS; and
a memory configured to store the CQI.

2. The apparatus of claim 1, wherein the PDCCH further comprises one of a DL DCI, an uplink UL DCI, or a joint DL and UL DCI.

3. The apparatus of claim 1, wherein the processing circuitry is to configure the gNB to transmit, to the UE, radio resource control (RRC) signaling that indicates offset and periodicity of the DM-RS.

4. The apparatus of claim 1, wherein:
the processing circuitry is to configure the gNB to indicate, to the UE, a power offset to be used for calculation of the CQI,
the power offset indicates a power ratio between the DM-RS of the PDCCH or PDSCH for which the CQI is calculated, and
the power offset is one of explicitly included in the DCI, able to be implicitly derived from the DCI, or provided to the UE in radio resource control (RRC) signaling.

5. The apparatus of claim 1, wherein the processing circuitry is to configure the gNB to indicate, in at least one of the DCI or radio resource control (RRC) signaling, timing of transmission of the UCI.

6. The apparatus of claim 1, wherein the processing circuitry is to configure the gNB to indicate, to the UE, to transmit the UCI in a soonest discrete Fourier transform spread orthogonal frequency division multiplexing (DFT-s-OFDM) symbol that satisfies a minimum time between a last symbol of the PDCCH and a first symbol of the UCI.

7. The apparatus of claim 1, wherein the processing circuitry is to configure the gNB to transmit, to the UE, an MCS table to derive the CQI, the CQI derived from a CQI index that corresponds to an MCS index of the MCS table.

8. The apparatus of claim 1, wherein the processing circuitry is to configure the gNB to:
transmit, to the UE, CSI reference signals (CSI-RS) on at least one of a plurality of multiple input multiple output (MIMO) beams during a beam management procedure, and
receive, from the UE, a CQI report together with a CSI-RS resource index (CRI) report, CQI in the CQI report is derived using the CSI-RS, the CRI report indicating preferred beamforming for at least one of DL or uplink (UL) transmissions.

9. The apparatus of claim 1, wherein:
the processing circuitry is to configure the gNB to transmit, to the UE, a set of power offsets to apply to measurements of the DM-RS for evaluation of a block error rate (BLER) based on a set of CQI, each power offset based on a modulation order corresponding to a different CQI in the set of CQI, and
the CQI takes into account reduction on transmission power by the UE to scale measurements of the DM-RS based on the set of power offsets.

10. The apparatus of claim 1, wherein:
the processing circuitry is to configure the gNB to transmit, to the UE, a set of power offsets to apply to measurements associated with DM-RS of a physical downlink shared channel (PDSCH) for evaluation of a block error rate (BLER) based on a set of CQI, each power offset based on a modulation order corresponding to a different CQI in the set of CQI, and
a CQI measurement based on the DM-RS associated with the PDSCH takes into account reduction on transmission power by the UE to scale measurements associated with the DM-RS of the PDSCH based on the set of power offsets.

11. The apparatus of claim 10, wherein:
the set of power offsets are to be applied to measurements associated with the DM-RS associated with the PDCCH and the DM-RS of the PDSCH for evaluation of the BLER, and
the processing circuitry is to configure the gNB to transmit, to the UE, an indication of selection of one of the DM-RS associated with the PDCCH or the DM-RS associated with PDSCH for BLER evaluation dependent on the modulation order associated with the CQI calculated from the DM-RS associated with the PDCCH and the CQI calculated from the DM-RS associated with PDSCH.

12. The apparatus of claim 1, wherein calculation of the CQI is not based on channel state information (CSI) reference signals (CSI-RS).

13. An apparatus for a user equipment (UE), the apparatus comprising:
processing circuitry to configure the UE to:
receive, from a 5^{th} generation NodeB (gNB) during a downlink (DL) period of a time domain duplexing (TDD) period, demodulation reference signals (DM-RS) associated with a physical downlink control channel (PDCCH), downlink control information (DCI) of the PDCCH, and a physical downlink shared channel (PDSCH);
calculate a channel quality indicator (CQI) based on the DM-RS; and
transmit, to the gNB, uplink control information (UCI) of a physical uplink control channel (PUCCH) or physical uplink shred channel (PUSCH), the UCI containing the CQI; and
a memory configured to store the CQI.

14. The apparatus of claim 13, wherein:
the processing circuitry is further configured to calculate the CQI based on a power offset,
the power offset indicates a power ratio between the DM-RS of the PDCCH or PDSCH for which the CQI is calculated, and
the power offset is one of explicitly included in the DCI, able to be implicitly derived from the DCI, or provided to the UE in radio resource control (RRC) signaling.

15. The apparatus of claim 13, wherein the processing circuitry is configured to determine timing of transmission of the UCI from at least one of the DCI or radio resource control (RRC) signaling.

16. The apparatus of claim 13, wherein the processing circuitry is to configure the UE to transmit the UCI in a soonest discrete Fourier transform spread orthogonal frequency division multiplexing (DFT-s-OFDM) symbol that satisfies a minimum time between a last symbol of the PDCCH and a first symbol of the UCI.

17. The apparatus of claim 13, wherein the processing circuitry is further configured to derive the CQI based on a modulation and coding scheme (MCS) table, a CQI index of the CQI correspond to an index of a MCS from the MCS table.

18. The apparatus of claim 13, wherein the processing circuitry is further configured to:
derive the CQI based on a set of power offsets to apply to the DM-RS for evaluation of a block error rate (BLER) based on a set of CQI, each power offset based on a modulation order corresponding to a different CQI in the set of CQI, and
scale measurements of the DM-RS depending on the CQI for the BLER.

19. A non-transitory computer-readable storage medium that stores instructions for execution by one or more processors of a 5^{th} generation NodeB (gNB), the one or more processors to configure the gNB to, when the instructions are executed:
transmit, to a user equipment (UE), a channel state information (CSI) reporting configuration, the CSI reporting configuration indicating use of demodulation reference signals (DM-RS) of a physical uplink control channel (PUCCH) or physical uplink shared channel (PUSCH) for reporting of a CSI;
transmit, to the UE, DM-RS and DCI of a PDCCH during a downlink (DL) period of a time domain duplexing (TDD) period, the DCI requesting the CSI reporting; and
in response to transmission of the DCI, receive, from the UE, a CSI calculated based on the DM-RS of the PDCCH during the DL period.

20. The non-transitory computer-readable storage medium of claim 19, wherein the CSI is channel quality information (CQI).
